(19) United States
(12) Patent Application Publication
(10) Pub. No.: US 2015/0169906 A1
(43) Pub. Date: Jun. 18, 2015

(54) AUTHENTICATION SYSTEM

(71) Applicant: Izhak Weintraub, Mount Kisco, NY (US)

(72) Inventor: Izhak Weintraub, Mount Kisco, NY (US)

(21) Appl. No.: 14/453,031

(22) Filed: Aug. 6, 2014

Related U.S. Application Data
(60) Provisional application No. 61/915,079, filed on Dec. 12, 2013.

(51) Int. Cl. G06K 5/00; G06K 19/06

(52) U.S. Cl. CPC G06K 5/00; G06K 19/06037; G06K 19/06028

(57) ABSTRACT

An authentication system includes a scratch-off code cover and an underlying code thereon for authentication operation operable as a unique product identifier. An interrelated database storing product authentication identification information is accessed by a user having a scanning system for operative scanning of the underlying code and for linking with and transmitting the same to the interrelated database. Upon a review of the database correlating to the underlying unique product identification the authentication system transmits an acceptance of the underlying code or a denial of the authentication.

### CROSS REFERENCE TO RELATED APPLICATIONS

This application relates to and claims priority from U.S. Prov. Ser. No. 61/915,079 filed Dec. 12, 2013, the entire contents of which are incorporated herein by reference.

### BACKGROUND OF THE INVENTION

The present invention relates to fraud prevention systems and, more particularly, to a scratch-off bar or QR code and software application for the prevention of counterfeiting.

Accordingly to the Organization For Economic Co-operation And Development (OECD), “the magnitude and effects of counterfeiting and piracy are of such significance that they compel strong and sustained action from governments, business and consumers. More effective enforcement is critical in this regard.” As can be seen, there is a need for a product authentication system that is consumer-friendly, engenders better data collection, and lends itself to effective enforcement.

### ASPECTS AND SUMMARY OF THE INVENTION

According to one aspect of the present invention, there is provided an authentication system includes a scratch-off code cover and an underlying code thereon for authentication operation operable as a unique product identifier. An interrelated database storing product authentication identification information is accessed by a user having a scanning system for operative scanning of the underlying code and for linking with and transmitting the same to the interrelated database. Upon a review of the database correlating to the underlying unique product identification the authentication system transmits an acceptance of the underlying code or a denial of the authentication.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a schematic view of an exemplary embodiment of the present invention with cover.

FIG. 2 is a schematic view of an exemplary embodiment of FIG. 1 with cover removed.

FIG. 3 is a schematic view of an exemplary alternative embodiment of the present invention.

FIG. 4 is a schematic view of an exemplary embodiment of FIG. 1 with cover removed.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a product authentication system. The product authentication system may include a bar or QR code, a database, a scratch-off surface, and a product authentication tool. The bar or QR code may be affixed to a particular product. The database may correlate the bar or QR code and the particular product. The scratch-off surface may conceal the bar or QR code. Further down the stream of commerce, a user may scratch off the scratch-off layer to reveal the bar or QR code. The user may then operate the product authentication tool so as to detect the bar code and remotely communicate with the database. The product authentication tool may authenticate whether the bar or QR code on the particular product matches the bar or QR code in the database match associated with the particular product.

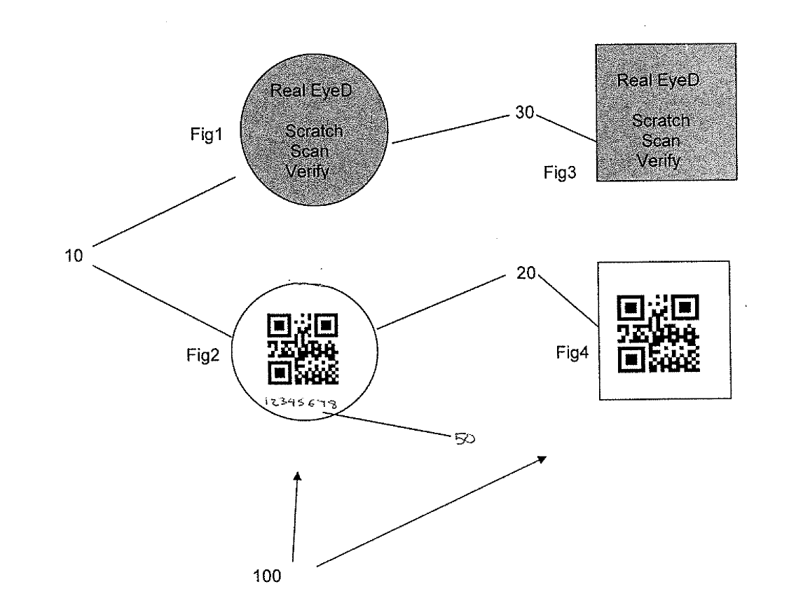

Referring now to FIGS. 1 through 4, the present invention may include a product authentication system 100. The product authentication system 100 may include a label 10 having a bar code or QR 20, a scratch-off surface 30 applied over a portion of the label 10, and an authentication verification tool. The scratch-off surface 30 may be removable and configured to conceal the bar or QR code 20.

The bar or QR code 20 may be a human-readable alphanumeric code, a 2D Bar code such as or a QR code or matrix code type, a multiple bar code layout, or a stacked bar code type, a Microsoft tag, a magnetic stripe or any of a variety of human or machine readable indicia. The bar code or QR 20 may include a predetermined unique number 50. The bar code 20 may be arranged to be read by an authentication verification tool.

The authentication verification tool may include at least one computer with a user interface. The computer may include any computer including, but not limited to, a desktop, laptop, and smart device, such as, a tablet and smart phone.

The computer includes a program product including a machine-readable program code for causing, when executed, the computer to perform steps.

The program product may include software which may either be loaded onto the computer or accessed by the computer. The loaded software may include a scanning application on a smart phone device.

The software may be accessed by the computer using a web browser. The computer may access the software via the web browser using the internet, extranet, intranet, host server, internet cloud and the like. The authentication verification tool may include a reading device and a database. The scanning application may remotely communicate with the database. The database may include a plurality of unique numbers 50. The database may link or otherwise correlate each unique number 50 to a particular product. In certain alternative and optional embodiments, the database may include a universal product code (UPC) code for the particular product. In certain embodiments, the database may link the particular product to a time and/or geographic chain of custody records. The database may record ownership of the particular product.

The method of using the present invention may include the following. The product authentication system 100 disclosed above may be provided. The label 10 with the unique number 50 may be affixed to the particular product. The database may correlate the unique number 50 and the particular product. Further down the stream of commerce, a user may scratch the scratch-off layer 30 to remove a portion of the scratch-off layer 30 so as to reveal the bar code 20. The user may then operate the product authentication tool so that the scanning application may detect the bar code 20 and may remotely communicate with the database. The scanning application may authenticate whether the unique number 50 on the particular product matches the unique number 50 found in the database for the particular product. In certain alternative and optional embodiments, the authentication verification tool may require input of the UPC code for the particular product.

The computer-based data processing system and method described above is for purposes of example only, and may be implemented in any type of computer system or programming or processing environment, or in a computer program, alone or in conjunction with hardware.

The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail.

It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet.

In addition, many embodiments of the present invention have application to a wide range of industries. To the extent the present scanning application discloses a system, the method implemented by that system, as well as software stored on a computer-readable medium and executed as a computer program to perform the method on a general purpose or special purpose computer, are within the scope of the present invention. Further, to the extent the present scanning application discloses a method, a system of apparatuses configured to implement the method are within the scope of the present invention. It should be understood, of course, that the foregoing relates to exemplary embodiments of the invention and that modifications may be made without departing from the spirit and scope of the invention as set forth in the following claims.

What is claimed is:

1. A verification system comprising:
a label having at least a surface, the surface including a bar Code or QR to be concealed thereon, wherein a removable scratch-off layer is provided on the surface over the bar code;
a predetermined unique number correlated with the bar or QR code;
a database correlating a particular product to the predetermined unique number; and
a product authentication tool arranged for scanning the barcode, wherein the product authentication tool is configured to communicates wireless with the database.
